(19) United States
(12) Patent Application Publication
(10) Pub. No.: US 2021/0080109 A1
(43) Pub. Date: Mar. 18, 2021

(54) VENTLESS DOWNDRAFT SYSTEM

(71) Applicant: Star Manufacturing International, Inc., Smithville, TN (US)

(72) Inventors: TODD M. FENTON, Nolensville, TN (US); Dean I. Griffey, McMinnville, TN (US); Jeffrey D. Tittsworth, Smithville, TN (US)

(73) Assignee: Star Manufacturing International, Inc., Smithville, TN (US)

(21) Appl. No.: 17/016,694

(22) Filed: Sep. 10, 2020

Related U.S. Application Data
(60) Provisional application No. 62/901,000, filed on Sep. 16, 2019.

(51) Int. Cl. F24B 5/04; B01D 46/00; B01D 46/10; F24C 15/20

(52) U.S. Cl. CPC F24B 5/04; B01D 46/0005; F24C 15/2042; F24C 15/2035; B01D 46/10

(57) ABSTRACT

A ventless downdraft system may include a housing; a table frame disposed on top of the housing, the table frame including a top surface; a first heating element and a second heating element supported by the table frame; a vent disposed between the first and second heating elements in the table frame and configured for directing smoke generated by the first and second heating elements downwardly into the housing; a vent cover disposed on the vent and outwardly from the top surface of the table frame, where the vent cover includes a first surface extending outwardly from the top surface of the table frame and facing the first heating element and a second surface extending outwardly from the top surface of the table frame and facing the second heating element; and a filter assembly disposed in the housing and configured for filtering the smoke directed into the housing.

### CROSS-REFERENCE TO RELATED APPLICATIONS

This application is a non-provisional application which claims priority to U.S. provisional application Ser. No. 62/901,000; filed Sep. 16, 2019, which is incorporated by reference herein in its entirety.

### TECHNICAL FIELD

The present disclosure relates to a ventless downdraft system that features completely self-contained air filtration, which does not require venting outside, making it possible to cook in nontraditional locations or when traditional hoods and ductwork are impractical.

### BRIEF SUMMARY OF THE INVENTION

One general aspect of the present disclosure includes a ventless downdraft system, including a housing; a table frame disposed on top of the housing, the table frame including a top surface; a first heating element and a second heating element supported by the table frame; a vent disposed between the first and second heating elements in the table frame and configured for directing smoke generated by the first and second heating elements downwardly into the housing; a vent cover disposed on the vent and outwardly from the top surface of the table frame, where the vent cover includes a first surface extending outwardly from the top surface of the table frame and facing the first heating element and a second surface extending outwardly from the top surface of the table frame and facing the second heating element; and a filter assembly disposed in the housing and configured for filtering the smoke directed into the housing.

Another general aspect of the present disclosure includes a ventless downdraft system, including a housing; a table frame disposed on top of the housing, the table frame including a top surface; a first heating element and a second heating element supported by the table frame; a vent disposed between the first and second heating elements in the table frame and configured for directing smoke generated by the first and second heating elements downwardly into the housing; a vent cover disposed on the vent and outwardly from the top surface of the table frame, where the vent cover includes a first surface extending outwardly from the top surface of the table frame and facing the first heating element and a second surface extending outwardly from the top surface of the table frame and facing the second heating element; and a filter assembly disposed in the housing and configured for filtering the smoke directed into the housing such that filtered smoke can be exhausted into a closed environment.

Another general aspect of the present disclosure includes a ventless downdraft system, including a housing; a table frame disposed on top of the housing, the table frame including a top surface; a first heating element and a second heating element supported by the table frame; a vent disposed between the first and second heating elements in the table frame and configured for directing smoke generated by the first and second heating elements downwardly into the housing; a vent cover disposed on the vent and outwardly from the top surface of the table frame; a filter assembly disposed in the housing and configured for filtering the smoke directed into the housing such that filtered smoke can be exhausted into a closed environment; and a hood extending upwardly from the top surface of the table frame, where the hood is configured to direct the smoke towards the vent along a second direction that is perpendicular to a first direction along which the vent cover directs the smoke towards the vent.

Other systems, methods, features and advantages of the invention will be, or will become, apparent to one with skill in the art upon examination of the following figures and detailed description. It is intended that all such additional systems, methods, features, and advantages be within the scope of the invention, and be encompassed by the following claims.

### BRIEF DESCRIPTION OF THE DRAWINGS

The present disclosure can be better understood with reference to the following drawings and description. The components in the figures are not necessarily to scale, emphasis instead being placed upon illustrating the principles of the present disclosure. Moreover, in the figures, like-referenced numerals designate corresponding parts throughout the different views.

FIG. 1 is a perspective view of an embodiment of a ventless downdraft system in accordance with certain aspects of the present disclosure.

FIG. 2 is a side view of an embodiment of a ventless downdraft system in accordance with certain aspects of the present disclosure.

FIG. 3 is a sectional view of the embodiment of the ventless downdraft system of FIG. 2 in accordance with certain aspects of the present disclosure.

FIG. 4 is a cutaway view of an embodiment of a ventless downdraft system in accordance with certain aspects of the present disclosure.

### DETAILED DESCRIPTION

Various aspects are described below with reference to the drawings in which like elements generally are identified by like numerals. The relationship and functioning of the various elements of the aspects may better be understood by reference to the following detailed description. However, aspects are not limited to those illustrated in the drawings or explicitly described below. It also should be understood that the drawings are not necessarily to scale, and in certain instances details may have been omitted that are not necessary for an understanding of aspects disclosed herein, such as conventional material, construction, and assembly. Also, the term “about” as used in the present application should be understood to communicate a definite and identifiable value range within parameters that would be understood by one of skill in the art and includes at least any legal equivalents, minor but functionally-insignificant variants, variants within standard manufacturing tolerances, and mathematically significant figures for the recited quantities.

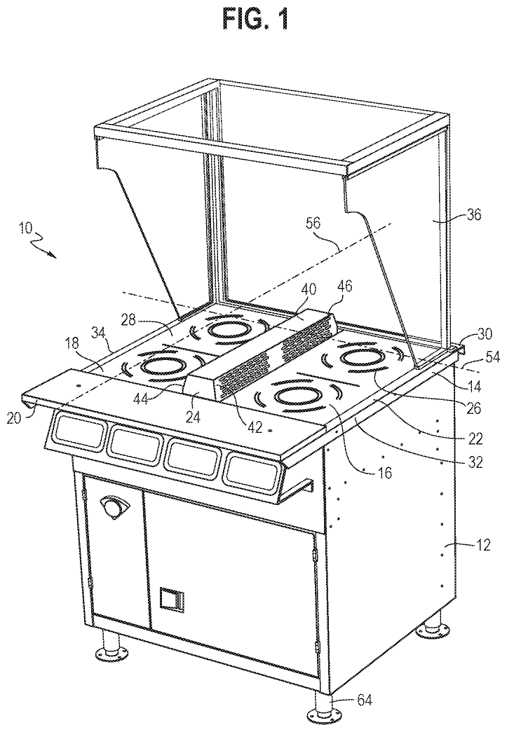

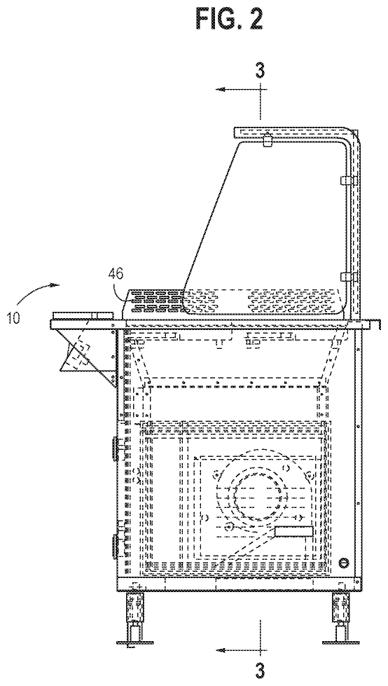

A ventless downdraft system 10 that may be used in nontraditional locations (e.g., gas station) or in traditional locations (e.g., indoor environment) where traditional hoods and ductwork are not available is shown in FIGS. 1-4. While a ventless downdraft system that is used for filtering the smoke generated during the preparation of food is specifically described herein, the ventless downdraft system may be successfully implemented for filtering the gas/smoke generated in other situations without the need of traditional ductwork for venting outside of a closed environment. For the sake of brevity, the smoke generator disclosed herein is described and depicted as a heating element configured for preparing food, one of ordinary skill in the art, with a thorough review of the subject specification and figures will readily comprehend how the ventless downdraft system may include or work with other smoke generators to filter the smoke, for safety and efficiency purposes and will readily comprehend which other smoke generators might be suitable without undue experimentation.

Referring to FIGS. 1-4, a ventless downdraft system 10 including a housing 12 and a table frame 14 disposed on top of the housing 12 is shown. A first heating element 16 and a second heating element 18 may be supported by the table frame 14, and disposed coplanar with or outwardly from a top surface 22 of the table frame 14. In some embodiments, as shown in FIG. 1, the first and second heating elements 16 and 18 may be disposed adjacent to a first side 20 of the table frame 14 and spaced apart by a vent 24 configured for directing the smoke generated by the first and second heating elements 16 and 18 (e.g., during preparing food using the first and second heating elements) downwardly into the housing 12, as discussed in greater detail below. It will be appreciated that one or more heating elements may be supported by the table frame 14, as desired and/or needed, without departing from the scope of the present invention. For example, as shown in FIG. 1, in addition to the first and second heating elements 16 and 18, a third heating element 26 and a fourth heating element 28 may also be supported by the table frame 14, which are disposed adjacent to a second side 30 of the table frame 14, opposite to the first side 20, and spaced apart by the vent 24. The first and third heating elements 16 and 26 may be located adjacent to a third side 32 of the table frame 14, and the second and fourth heating elements 18 and 28 may be located adjacent to a fourth side 34 of the table frame 14, opposite to the third side 32. In some embodiments, the first side 20 may extend generally parallel to the second side 30, the third side 32 may extend generally parallel to the fourth side 34, and the first and second sides 20 and 30 may extend generally perpendicular to the third and fourth sides 32 and 34.

In some embodiments, the first, second, third, and fourth heating elements 16, 18, 26, and 28 may be configured for preparing food (e.g., induction burners), and the first side 20 of the table frame 14 may be the side where a chef may be located while preparing food on the heating elements, and the other sides 30, 32, and 34 of the table frame 14 may be the sides where customers may be located while observing the cooking or enjoying the food. In some embodiments, as shown in FIG. 1, the ventless downdraft system 10 may include a hood 36 extending outwardly from the second, third, and fourth sides 30, 32, and 34 of the table frame 14 and above at least a portion of the top surface 22 of the table frame 14 (e.g., above at least a portion of the third and fourth heating elements 26 and 28). The hood 36 may be configured to facilitate preventing the smoke generated by the heating elements from escaping the top surface 22 of the table frame 14 from the second side 30, as discussed in greater detail below. In some embodiments, the hood 36 is not included.

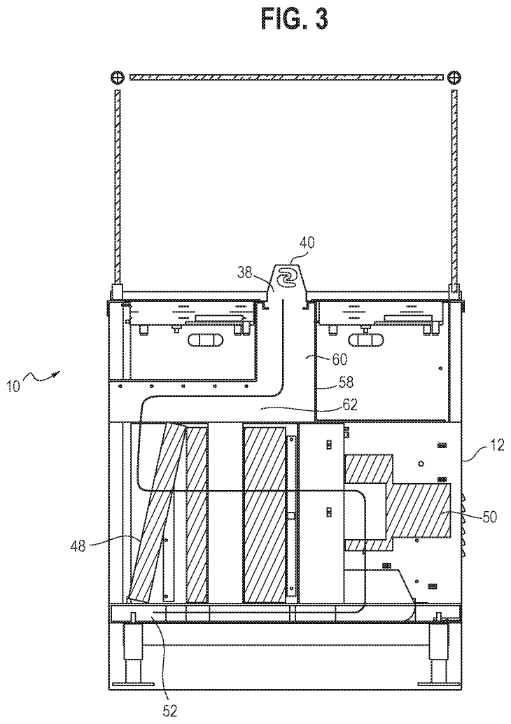

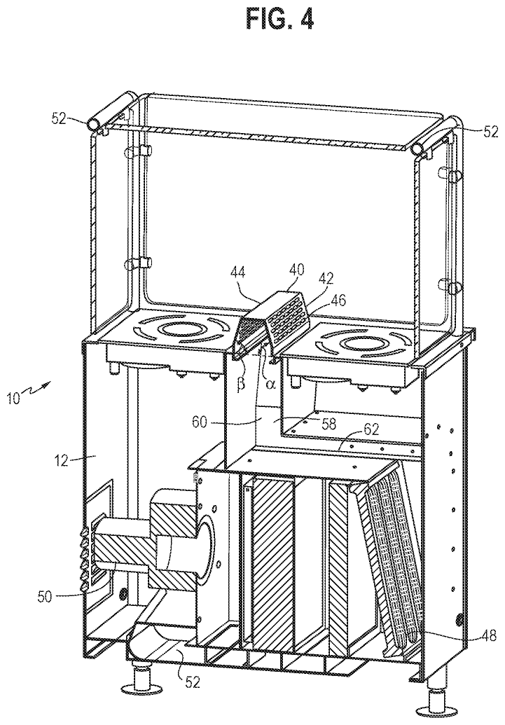

In some embodiments, as shown in FIGS. 1 and 3, the vent 24 may extend between the first and second sides 20 and 30 of the table frame 14 and may define an aperture 38 extending therebetween. The aperture 38 may be in fluid communication with a blower 50 disposed in the housing 12, as discussed in greater detail below, such that the smoke generated by the heating elements may be pulled downwardly into the housing 12 through the aperture 38. A filter assembly 48 may be disposed in the housing 12 (e.g., upstream of the blower 50) and configured for filtering the smoke directed into the housing 12, such that the filtered smoke may be exhausted outside the housing 12 through at least one outlet 52, as discussed in greater detail below. As shown in FIG. 3, the at least one outlet 52 may extend upwardly from the top surface 22 of the table frame 14 (e.g., as shown in FIG. 4) and/or disposed on a bottom surface of the housing 12 (e.g., as shown in FIGS. 3 and 4). In some embodiments, the exhaust aft is horizontally powered by a ¼th hp motor, and the exhaust airflow may be about 800 CFM. It will be appreciated that the at least one outlet 52 may have various configurations and positions, as desired and/or needed, without departing from the scope of the present invention, as long as the smoke filtered by the filter assembly 48 may be exhausted outside the housing 12 through the at least one outlet 52.

A vent cover 40 may be disposed on the aperture 38 and outwardly from the top surface 22 of the table frame 14. The vent cover 40 may be configured for facilitating the direction of the smoke generated by the heating elements downwardly into the housing 12. For example, as shown in FIG. 1, the vent cover 40 (e.g., and also the aperture 38) may extend generally the length of the first and the third heating elements 16 and 26 (e.g., and also the length of the second and the fourth heating elements 18 and 28) and extend generally a height between about 2 and about 5 (inclusive of all values within this range), depending upon the number, configuration, and dimension of the heating elements, to ensure a generally complete capture of the generated smoke.

In some embodiments, as shown in FIGS. 1 and 4, the vent cover 40 may include a first surface 42 extending outwardly from the top surface 22 of the table frame 14 and facing the first heating element 16 and a second surface 44 extending outwardly from the top surface 22 of the table frame 14 and facing the second heating element 18. Each of the first surface 42 and the second surface 44 of the vent cover 40 may include a plurality of slots 46 extending horizontally along a length of the vent cover 40. The horizontally extending slots 46 are advantageous for providing greater contact areas between the smoke and the vent cover 40, thereby enhancing the efficiency of drawing the smoke downwardly into the housing 12. In some embodiments, as shown in FIGS. 1 and 4, each of the first surface 42 and the second surface 44 of the vent cover 40 may include one or more rows of the plurality of horizontally extending slots 46, such that the smoke diffused at various heights may be directed into the aperture 38 through the corresponding row(s) of the slots, which may further enhance the efficiency of capturing the generated smoke.

In some embodiments, as shown in FIG. 4, the first surface 42 of the vent cover 40 may extend outwardly from the top surface 22 of the table frame 14 at a first angle α that may be between about 45 degrees and about 80 degrees and away from the first heating element 16, and the second surface 44 of the vent cover 40 may extend outwardly from the top surface 22 of the table frame 14 at a second angle β that may be between about 45 degrees and about 80 degrees and away from the second heating element 18. The term “about” is specifically defined herein to include the specific value referenced as well as a dimension that is within 5% of the dimension both above and below the dimension. In these embodiments, the vent cover 40 may have a cross-section that has a generally trapezoid configuration with the greater bottom side in communication with the aperture 38. It will be appreciated that the vent cover 40 may have various configurations of the cross section, as desired and/or needed, without departing from the scope of the present invention, including, but not limited to, square, rectangular, and triangular. The smoke generated by the heating elements may diffuse as it goes up from the heating elements, and the trapezoid configuration of the cross section of the vent cover 40 is advantageous for providing corresponding slots to accommodate the diffused smoke, such that the diffusion of the smoke may contribute to the capture of the smoke by the blower 50 through the corresponding slots.

In some embodiments, as shown in FIG. 1, the vent 24 and the heating elements 16, 18, 26, and 28 are disposed such that the vent 24 may extend between the first side 20 (e.g., the chef side) and the second side 30 (e.g., the hood side) of the table frame 14 with the heating elements 16, 18, 26, and 28 disposed on the opposite sides of the vent 24. For example, the vent 24 may extend generally perpendicular to the first side 20 and to a portion of the hood 36 that extends vertically upwardly from the second side 30. In combination of the configuration of the vent cover 40 as discussed above, this positioning of the vent 24/vent cover 40 and the heating elements 16, 18, 26, and 28 is advantageous as it allows the generated smoke to be directed, towards the vent 24, away from the third and fourth sides 32 and 34 of the table frame 14 (e.g., customer sides), along a first direction 54 (e.g., generally parallel to the first side 20 (e.g., the chef side)), thereby reducing/eliminating the amount of smoke that flows towards the chef and the customers, making their experience more pleasant during the preparation of food.

Disposing the vent 24/vent cover 40 between the heating elements also provides the ability to accommodate a greater number of individual heating elements on a table frame with a certain dimension, as a single vent cover 40 may provide two surfaces that simultaneously capture the smoke generated by each individual heating element, thereby increasing the space utilization rate. With the greater number of individual heating elements, users can mix and match various cooking utensils, such as pots, pans, and griddle plates, thereby enhancing the cooking efficiency. In addition, this positioning, comparing to positioning the vent 24/vent cover 40 on one side of all the heating elements, may allow for a shorter distance between the vent 24 and each heating element, such that the efficiency and completeness of capturing the smoke may be improved.

As discussed above, the hood 36 may be configured to facilitate preventing the smoke from flowing along a second direction 56 (e.g., generally parallel to the third and fourth sides 32 and 34) away from the second side 30 or flowing along the first direction 54 away from the third and fourth sides 32 and 34. It will be appreciated that the positioning of the vent 24/vent cover 40 and the hood 36 discussed above is advantageous because it provides the ability to direct the generated smoke towards the vent 24 along both the first direction 54 (e.g., primarily by the vent cover 40) and the second direction 56 (e.g., generally perpendicular to the first direction 54; primarily by the hood 36), thereby enhancing the completeness of capturing the generated smoke.

In some embodiments, as shown in FIGS. 3 and 4, the ventless downdraft system 10 may include an exhaust duct 58 disposed in the housing 12 and in fluid communication with the vent 24 and the filter assembly 48, such that the generated smoke may pass through the vent cover 40 and the aperture 38, into the exhaust duct 58, and then pass through the filter assembly 48. The exhaust duct 58 may include a vertical portion 60 and a horizontal portion 62 that is downstream of and in fluid communication with the vertical portion 60. The vertical portion may be directly connected to the vent 24 (e.g., aperture 38) and the horizontal portion 62 may be disposed above and in fluid communication with the filter assembly 48. It will be appreciated that the configuration, orientation, and dimension of the exhaust duct 58 may be varied, as desired and/or needed, depending on the design needs of the ventless downdraft system, without departing from the scope of the present invention.

In some embodiments, as shown in FIGS. 3 and 4, the blower 50 may be disposed downstream of the filter assembly 48. The filter assembly 48 may be configured to allow for a four-stage filtration process, for example, including a stainless steel grease baffle filter with grease tray, fiberglass pre-filters, a high-efficiency air filter, and a carbon-charcoal filter pack. All of these filters may be easily removable without tools, allowing easy cleaning and/or replacement. The filter assembly 48 is configured such that the filtered smoke (after passing through the filter assembly 48) will meet the standard for air to be exhausted into a closed environment without the requirement for fresh make-up air. For example, the filtered smoke exhausted outside of the housing 12 may include less than 5 mg/cubic meter of grease. The configuration of the blower 50 and the filter assembly 48 provides the ability to filter the smoke without the need for fresh air make-up or the need for outside exhausts, which allows the ventless downdraft system 10 to be used (e.g., for preparing food) in nontraditional locations (e.g., gas station) or when traditional hoods and ductwork are impractical, restricted, or too expensive. Positioning the blower 50 and the filter assembly 48 within the housing 12 underneath the heating elements is also advantageous for reducing/eliminating the smoke that diffuses into the closed environment before being filtered, thereby improving the air quality of the closed environment and allowing a chef to cook in a position that is close to people (e.g., customers). This positioning also improves the space utilization rate.

In some embodiments, the ventless downdraft system 10 may include at least one air flow sensor disposed within the exhaust duct 58. The air flow sensor may continually monitor the air flow optimizing performance and grease removal such that the ventless downdraft system 10 will not allow the heating elements to function if filters of the filter assembly 48 are missing, clogged or in the event of a fire. In some embodiments, a muffler may be provided in the housing 12 to reduce noise of the system 10, such that the system 10 may be very quiet with less than about 70 dBA on average. In some embodiments, as shown in FIG. 1, the ventless downdraft system 10 may include four adjustable legs (e.g., adjustable by about 2 inches for leveling). In some embodiments, the ventless downdraft system 10 may be movable, which makes it ideal for leased properties.

While various embodiments of the present disclosure have been described, the present disclosure is not to be restricted except in light of the attached claims and their equivalents. One skilled in the relevant art will recognize that numerous variations and modifications may be made to the embodiments described above without departing from the scope of the present invention, as defined by the appended claims. Moreover, the advantages described herein are not necessarily the only advantages of the present disclosure and it is not necessarily expected that every embodiment of the present disclosure will achieve all of the advantages described.

We claim:

1. A ventless downdraft system, comprising:
a housing;
a table frame disposed on top of the housing, the table frame including a top surface;
a first heating element and a second heating element supported by the table frame;
a vent disposed between the first and second heating elements in the table frame and configured for directing smoke generated by the first and second heating elements downwardly into the housing;
a vent cover disposed on the vent and outwardly from the top surface of the table frame, wherein the vent cover includes a first surface extending outwardly from the top surface of the table frame and facing the first heating element and a second surface extending outwardly from the top surface of the table frame and facing the second heating element; and
a filter assembly disposed in the housing and configured for filtering the smoke directed into the housing.

2. The ventless downdraft system of claim 1, further comprising at least one outlet configured for exhausting filtered smoke outside the housing.

3. The ventless downdraft system of claim 2, wherein the filtered smoke exhausted outside the housing from the at least one outlet includes grease that is less than 5 mg/cubic meter.

4. The ventless downdraft system of claim 2, wherein the at least one outlet extends upwardly from the top surface of the table frame or is disposed on a bottom surface of the housing.

5. The ventless downdraft system of claim 1, wherein each of the first surface and the second surface of the vent cover further comprises a plurality of slots extending horizontally along a length of the vent cover.

6. The ventless downdraft system of claim 1, wherein the first surface of the vent cover extends outwardly from the top surface of the table frame at a first angle between about 45 degrees and about 80 degrees and away from the first heating element, and wherein the second surface of the vent cover extends outwardly from the top surface of the table frame at a second angle between about 45 degrees and about 80 degrees and away from the second heating element.

7. The ventless downdraft system of claim 1, further comprising an exhaust duct disposed in the housing and in fluid communication with the vent and the filter assembly, wherein the exhaust duct includes a vertical portion directly connected to the vent and a horizontal portion disposed above the filter assembly.

8. The ventless downdraft system of claim 1, further comprising a hood extending upwardly from the top surface of the table frame, wherein the hood is configured to direct the smoke towards the vent along a second direction that is perpendicular to a first direction along which the vent cover directs the smoke towards the vent.

9. The ventless downdraft system of claim 1, further comprising a blower disposed in the housing and configured for pulling the smoke generated by the first and second heating elements downwardly into the housing.

10. The ventless downdraft system of claim 1, further comprising a muffler configured to reduce noise.

11. The ventless downdraft system of claim 1, wherein the first and second heating elements include an induction burner.

12. A ventless downdraft system, comprising:
a housing;
a table frame disposed on top of the housing, the table frame including a top surface;
a first heating element and a second heating element supported by the table frame;
a vent disposed between the first and second heating elements in the table frame and configured for directing smoke generated by the first and second heating elements downwardly into the housing;
a vent cover disposed on the vent and outwardly from the top surface of the table frame, wherein the vent cover includes a first surface extending outwardly from the top surface of the table frame and facing the first heating element and a second surface extending outwardly from the top surface of the table frame and facing the second heating element; and
a filter assembly disposed in the housing and configured for filtering the smoke directed into the housing such that filtered smoke can be exhausted into a closed environment.

13. The ventless downdraft system of claim 12, wherein each of the first surface and the second surface of the vent cover further comprises a plurality of slots extending horizontally along a length of the vent cover.

14. The ventless downdraft system of claim 12, wherein the first surface of the vent cover extends outwardly from the top surface of the table frame at a first angle between about 45 degrees and about 80 degrees and away from the first heating element, and wherein the second surface of the vent cover extends outwardly from the top surface of the table frame at a second angle between about 45 degrees and about 80 degrees and away from the second heating element.

15. The ventless downdraft system of claim 12, further comprising an exhaust duct disposed in the housing and in fluid communication with the vent and the filter assembly, wherein the exhaust duct includes a vertical portion directly connected to the vent and a horizontal portion disposed above the filter assembly.

16. The ventless downdraft system of claim 12, further comprising a hood extending upwardly from the top surface of the table frame, wherein the hood is configured to direct the smoke towards the vent along a second direction that is perpendicular to a first direction along which the vent cover directs the smoke towards the vent.

17. A ventless downdraft system, comprising:
a housing;
a table frame disposed on top of the housing, the table frame including a top surface;
a first heating element and a second heating element supported by the table frame;
a vent disposed between the first and second heating elements in the table frame and configured for directing smoke generated by the first and second heating elements downwardly into the housing;
a vent cover disposed on the vent and outwardly from the top surface of the table frame;
a filter assembly disposed in the housing and configured for filtering the smoke directed into the housing such that filtered smoke can be exhausted into a closed environment; and
a hood extending upwardly from the top surface of the table frame, wherein the hood is configured to direct the smoke towards the vent along a second direction that is perpendicular to a first direction along which the vent cover directs the smoke towards the vent.

18. The ventless downdraft system of claim 17, wherein the vent cover includes a first surface extending outwardly from the top surface of the table frame and facing the first heating element and a second surface extending outwardly from the top surface of the table frame and facing the second heating element.

19. The ventless downdraft system of claim 18, wherein the first surface of the vent cover extends outwardly from the top surface of the table frame at a first angle between about 45 degrees and about 80 degrees and away from the first heating element, and wherein the second surface of the vent cover extends outwardly from the top surface of the table frame at a second angle between about 45 degrees and about 80 degrees and away from the second heating element.
